(19) United States
(12) Patent Application Publication
(10) Pub. No.: US 2025/0021981 A1
(43) Pub. Date: Jan. 16, 2025

(54) NOTIFICATION SETTINGS FOR DATA TRANSACTIONS

(71) Applicant: Motorola Mobility LLC, Chicago, IL (US)

(72) Inventors: Krishnan Raghavan, Bangalore (IN); Rahul Sahadevan, Bengaluru (IN); Nakul Patel, Bangalore (IN)

(73) Assignee: Motorola Mobility LLC, Chicago, IL (US)

(21) Appl. No.: 18/222,038

(22) Filed: Jul. 14, 2023

(51) Int. Cl. G06Q 20/40

(52) U.S. Cl. CPC G06Q 20/4016

(57) ABSTRACT

Techniques for notification settings for data transactions are described and are implementable to enable a notification settings override to be applied. For instance, when a requested data transaction for a user account exceeds a specified risk threshold and a user device associated with the user account has a notification setting that prevents output of a notification of the data transaction, a notification settings override can be applied on the user device to enable a notification of the requested data transaction to be output.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without risks. For instance, unauthorized entities (e.g., hackers) can obtain access to user finance accounts and perform unauthorized transactions, such as transferring value away from user accounts. Such financial systems, in addition to traditional fraud prevention systems, often try to ensure the safety of the user account through a notification mechanism that can inform the users of such attempts and allow them to act on it in a timely manner.

### BRIEF DESCRIPTION OF THE DRAWINGS

Aspects of notification settings for data transactions are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of notification settings for data transactions can be implemented.

FIG. 2 depicts an example system for overriding notification settings for data transactions in accordance with one or more implementations.

FIG. 3a depicts an example transaction notification graphical user interface (GUI) in accordance with one or more implementations.

FIG. 3b depicts an example transaction notification GUI in accordance with one or more implementations.

FIG. 4 illustrates a flow chart depicting an example method for notification settings for data transactions in accordance with one or more implementations.

FIG. 5 illustrates a flow chart depicting an example method for notification settings for data transactions in accordance with one or more implementations.

FIG. 6 illustrates a flow chart depicting an example method for notification settings for data transactions in accordance with one or more implementations.

FIG. 7 illustrates various components of an example device in which aspects of notification settings for data transactions can be implemented.

### DETAILED DESCRIPTION

Techniques for notification settings for data transactions are described and are implementable to enable notifications of data transactions (e.g., payment transactions, an account activity such as an account login, etc.) to be output by devices in scenarios where device notification settings may prevent notification output. For instance, the described techniques enable device notification settings to be overridden to enable notifications of critical data transactions to be output.

For instance, consider a scenario in which a user configures notification settings of a user device (e.g., a smartphone) to prevent notification output. For example, the user attends a meeting and silences device notifications to prevent disrupting the meeting. During the meeting, however, another party (e.g., a malicious party) attempts to access the user's data. The other party, for example, attempts to access user finance information, such as to attempt to perform an unauthorized value transfer (e.g., money transfer) out of the user's account into another account. A network transaction service (e.g., a bank, a digital payment service, etc.) detects the requested transaction and determines that the transaction exceeds a risk threshold such that the user is to be notified and/or user permission for the transaction is to be obtained.

The network transaction service, however, determines that current notification settings of the user device prevent output of a notification of the requested data transaction. Accordingly, the network transaction service communicates a notification to the user device to override current notification settings of the user device and to output information about the requested data transaction. The user device receives the notification, applies a notification setting override, and outputs an indication of the requested data transaction. The indication of the data transaction, for instance, identifies parameters of the requested data transaction, e.g., a request for access to user data, a request to manipulate user value amounts (e.g., money), etc. The indication of the data transaction can also include selectable options to allow the data transaction to proceed or to block the data transaction.

Further to implementations, a user of the user device can interact with the indication of the data transaction such as to allow or block the data transaction. Further, the user and/or the user device can acknowledge receipt and output of the indication of the data transaction, such as to the network transaction service. After receiving an acknowledgement of the indication of the data transaction, the network transaction service can communicate a further instruction to the user device to revert to previous notification settings, e.g., notification settings that were in effect prior to initiation of the requested data transaction.

Accordingly, techniques described herein enable detection and management (e.g., prevention) of potentially malicious data transactions. In implementations, a data transaction represents a payment transaction, a login attempt, a password change attempt, etc. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling the detection and management of potentially malicious data transactions, the described techniques can increase data security and conserve system resources (e.g., memory, processor bandwidth, network bandwidth, etc.) that may otherwise be used to detect and correct such data transactions, and thus the described techniques can improve the operation of computing devices and data networks. Further, user burden can be reduced by performing such corrective processes automatically while reducing user interaction to initiate and manage the preventative and corrective processes.

While features and concepts of notification settings for data transactions can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

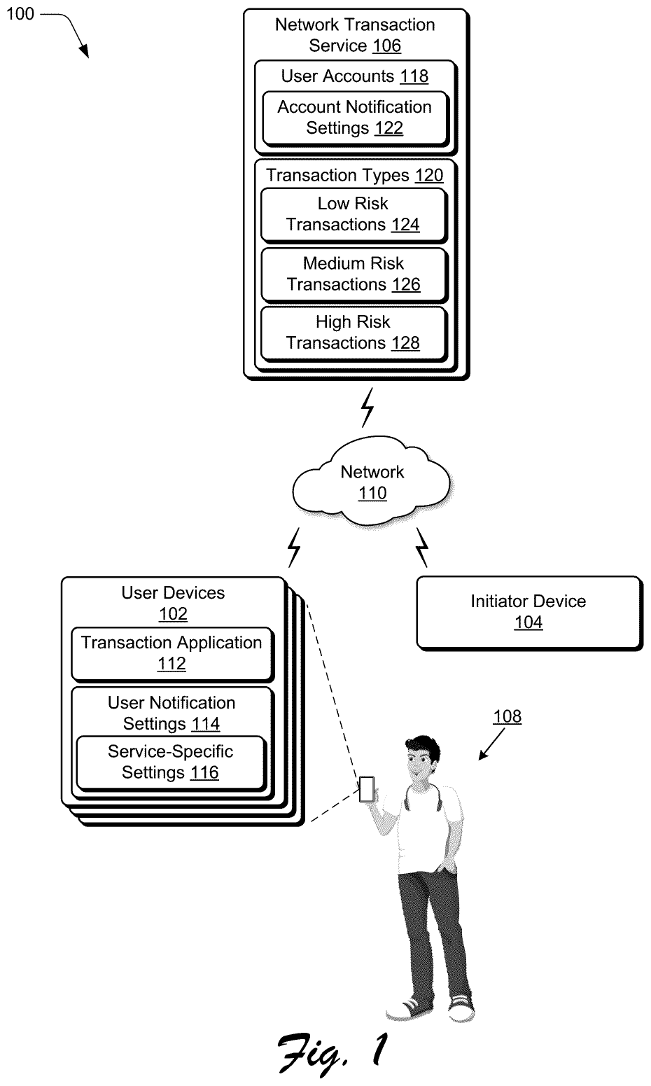

FIG. 1 illustrates an example environment 100 in which aspects of notification settings for data transactions can be implemented. The environment 100 includes user devices 102, an initiator device 104, and a network transaction service 106. The user devices 102 represent devices that can be used by a user 108 to manage different data transactions, e.g., finance transactions. The initiator device 104 represents a device that can be utilized to initiate a data transaction. The initiator device 104, for instance, may represent an instance of a user device 102. Alternatively, the initiator device 104 may represent a device utilized to attempt to obtain unauthorized access to user data (e.g., finance accounts), e.g., a device that is not associated with and/or registered to the user 108.

The network transaction service 106 represents a network-based service that is accessible to the user devices 102 and the initiator device 104 via a network 110. The network transaction service 106 can be implemented by various entities, such as a banking entity, a payment service, an enterprise entity, a trading entity, and/or combinations thereof. The user 108, for instance, can utilize a transaction application 112 on the user device 102 to access the network transaction service 106 to perform different finance transactions, such as to transfer value amounts (e.g., monetary values) for different purposes. The transaction application 112, for example, represents functionality that enables various finance-related transactions to be performed via the user devices 102, including access to the network transaction service 106.

Further to the environment 100 the user devices 102 include user notification settings 114 which are configurable to specify ways in which different notifications can be presented via the user devices 102. The user notification settings 114, for instance, specify notification behaviors for various types of notifications, such as audible, visual, and tactile notifications. In implementations the user notification settings 114 are user configurable, such as to specify different notification settings in different usage scenarios. Further, the user notification settings 114 include service-specific settings 116 which specify different notification behaviors for notifications pertaining to the network transaction service 106. For instance, and as further detailed below, the service-specific settings 116 can indicate different ways in which notifications from the network transaction service 106 to the user devices 102 are to be handled.

The network transaction service 106 includes various data and functionality for aspects of notification settings for data transactions, including user accounts 118 and transaction types 120. The user accounts 118 represent information defining different user-specific settings for different users of the network transaction service 106. The user accounts 118, for instance, include a user account 118 for the user 108 of the user devices 102. The user accounts 118 include account notification settings 122 that represent notification settings that can be configured and customized for each user account 118. The account notification settings 122, for instance, specify ways in which notifications are to be communicated from the network transaction service 106 to the user devices 102, and ways in which notifications from the network transaction service 106 to the user devices 102 are to be processed (e.g., output) by the user devices 102.

The transaction types 120 represent different types of finance transactions that can be implemented via the network transaction service 106. The transaction types 120 can be categorized in different ways, which in this particular example include low risk transactions 124, medium risk transactions 126, and high risk transactions 128. The different transaction types 120, for instance, are categorized based on a level of security risk associated with different transactions. For example, the low risk transactions 124 represent finance transactions with a low security risk (e.g., low potential security impact), the medium risk transactions 126 represent finance transactions with a medium security risk (e.g., medium potential security impact), and the high risk transactions 128 represent finance transactions with a high security risk, e.g., high potential security impact.

Example implementations of the transaction types 120 are presented in Table 1 below. These different transaction types 120 are presented for the purpose of example only, and it is to be appreciated that transactions can be defined and categorized in a variety of different ways within the scope of the disclosed and claimed implementations.

TABLE 1

| Low Risk | | Medium Risk | | High Risk | |
|---|---|---|---|---|---|
| Transactions 124 | | Transactions 126 | | Transactions 128 | |
| 1. | View Transaction | 1. | User login from a | 1. | User login detected |
| | Service | | different device | | as a location a |
| | Information | | that a current | | threshold distance |
| 2. | Communication | | device on which | | from the user's |
| | with Transaction | | user is logged in | | current location |
| | Service | 2. | Money | 2. | Money |
| | . . . | | withdrawal/ | | withdrawal/transfer |
| | | | transfer below | | above a threshold |
| | | | a threshold | | amount |
| | | | amount | | |
| | | 3. | User profile | 3. | Multiple |
| | | | change | | consecutive value |
| | | | . . . | | transactions within |
| | | | | | a threshold period |
| | | | | | of time |
| | | | | | . . . |

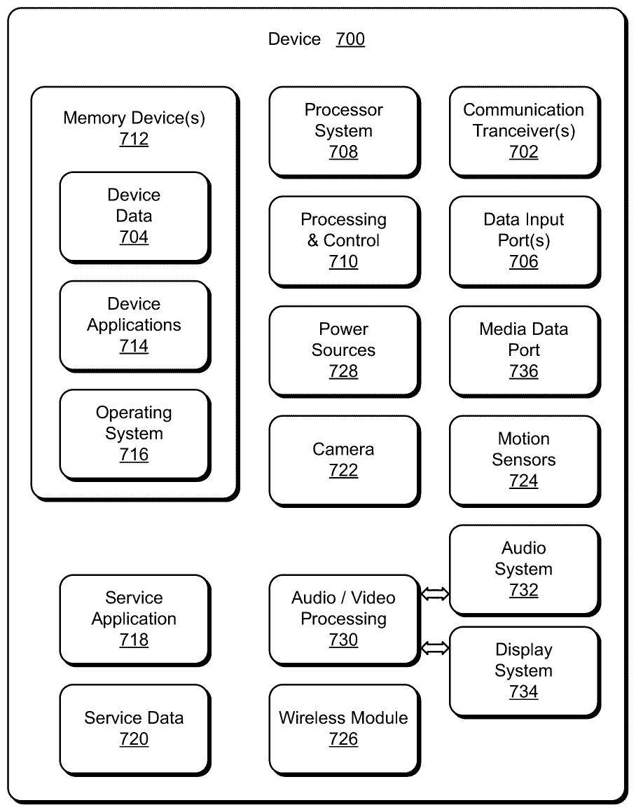

The user devices 102, the initiator device 104, and/or the network transaction service 106 can be implemented in various ways and include various functionality, examples of which are discussed below with reference to the example device 700 of FIG. 7. Further, the network 110 can represent a combination of wired and wireless networks via which the user devices 102, the initiator device 104, and/or the network transaction service 106 can participate in various types of communication, such as wired and/or wireless data communication.

Having discussed an example environment in which the disclosed techniques can be performed, consider now some example scenarios and implementation details for implementing the disclosed techniques.

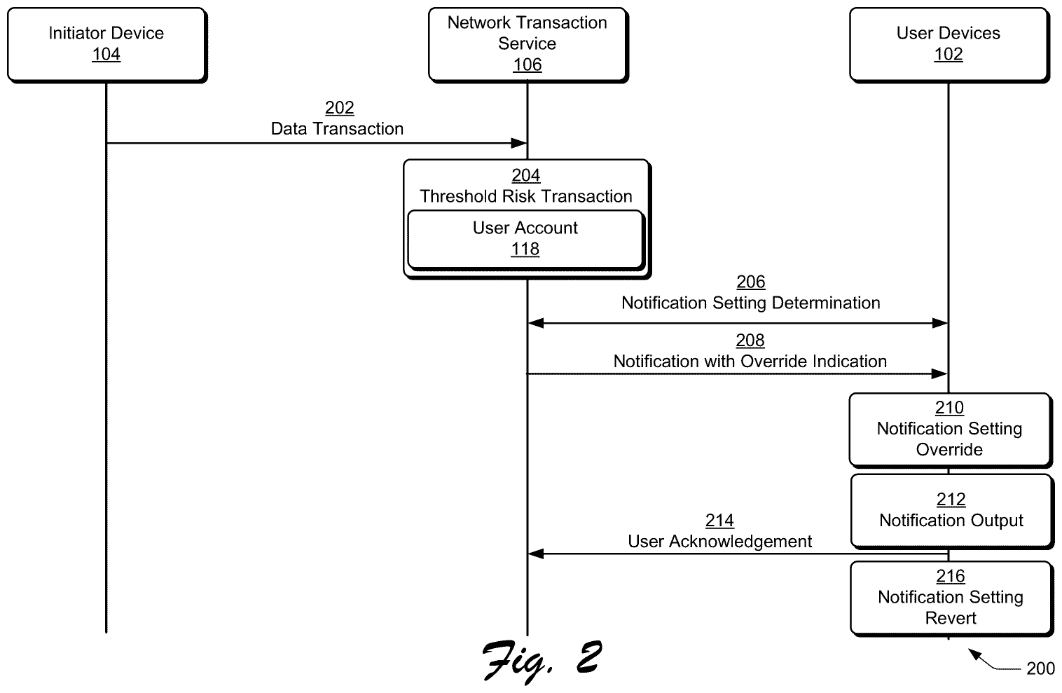

FIG. 2 depicts an example system 200 for overriding notification settings for data transactions in accordance with one or more implementations. The system 200 can be implemented in the environment 100 and incorporates attributes of the environment 100 introduced above. In the system 200, the initiator device 104 initiates a data transaction 202 with the network transaction service 106. The data transaction 202 can represent various types of data-based transactions, such a request for access to data, a finance transaction, and combinations thereof. The network transaction service 106 receives the data transaction 202 and determines that the data transaction 202 represents a threshold risk transaction 204. For instance, the network transaction service 106 determines that the data transaction 202 represents a medium risk transaction 126 and/or a high risk transaction 128. Further, the network transaction service 106 determines that the data transaction 202 is associated with a user account 118.

Accordingly, the network transaction service 106 performs a notification setting determination 206 to determine notification settings of one or more user devices 102 associated with the user account 118, e.g., user devices 102 registered to the user account 118. As part of the notification setting determination 206, for example, the network transaction service 106 communicates a settings query to the one or more user devices 102 requesting one or more notification settings of the user devices 102. The user devices 102 can then return a query response indicating current notification settings of the user devices 102.

Further to the system 200, the network transaction service 106 communicates a notification with override indication 208 to user devices 102. For instance, based at least in part on the notification setting determination 206, the network transaction service 106 determines that a notification setting override is to be implemented for a notification of the data transaction 202 to be output by the one or more user devices 102.

According to implementations, the notification with override indication 208 identifies attributes of the data transaction 202, e.g., a data transaction type and parameters of the data transaction 202. Further, the notification with override indication 208 includes an instruction to override notification settings of the user devices 102, e.g., the user notification settings 114. For instance, the notification with override indication 208 indicates that if the user notification settings 114 indicate that the user devices 102 currently have notifications turned off (e.g., are in silent mode), the user notification settings 114 are to be modified (e.g., overridden) to output the notification via the user devices 102.

Further to the system 200 and based at least in part on the notification with override indication 208, the user devices 102 perform a notification setting override 210 and perform notification output 212. One or more of the user devices 102, for instance, modify current user notification settings 114 to allow the notification output 212. A user acknowledgement 214 can be communicated from a user device 102 to the network transaction service 106 acknowledging receipt of the notification with override indication 208. Further, the user acknowledgement 214 can include an indication to allow the data transaction 202 to be performed via the network transaction service 106 or an indication to block (e.g., disallow) the data transaction 202. The user devices 102 can implement a notification setting revert 216 to reapply notification settings of the user devices 102 that were in effect prior to receiving the notification with override indication 208. According to implementations, the various communications and modifications (e.g., setting modifications) discussed in the system 200 can be automatically applied without direct user interaction to modify notification settings.

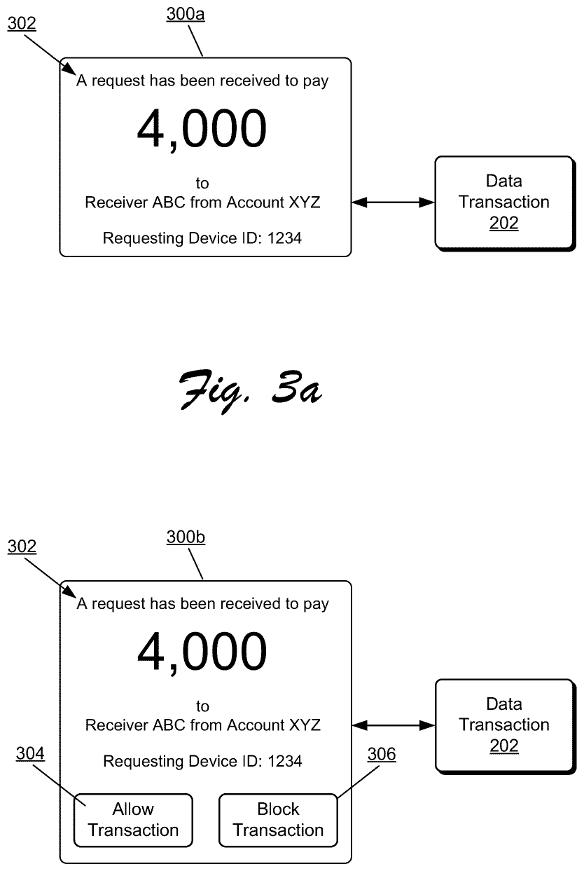

FIG. 3a depicts an example transaction notification graphical user interface (GUI) 300a in accordance with one or more implementations. The transaction notification GUI 300a, for instance, is presented via one or more user devices 102 and enables a user to view information about a requested data transaction and to perform different actions pertaining to the data transaction. The transaction notification GUI 300a may be generated, presented, and/or managed by the transaction application 112, the network transaction service 106, and/or cooperatively between the transaction application 112 and the network transaction service 106. Further, the transaction notification GUI 300a may be presented after a notification setting override, such as described throughout this disclosure.

FIG. 3b depicts an example transaction notification GUI 300b in accordance with one or more implementations. The transaction notification GUI 300b, for instance, represents a variation of the transaction notification GUI 300a and can incorporate attributes of the transaction notification GUI 300a discussed above.

The transaction notification GUI 300a includes the transaction information field 302 that includes various information about a requested data transaction 202, such as a type of data transaction (e.g., a request to pay value to a party), a transaction amount, a receiving party, an account identifier, and a device identifier (ID) for a device (e.g., an initiator device 104) that originated the request.

The transaction notification GUI 300b can also include an allow control 304 and a block control 306. The allow control 304, for instance, is selectable to allow the identified data transaction 202 to proceed. For example, in response to user selection of the allow control 304, an acknowledgement is sent from a user device 102 to the network transaction service 106 to instruct the network transaction service 106 to allow a requested data transaction 202 to proceed. The block control 306 is selectable to block a requested data transaction 202. Selection of the block control 306, for instance, causes an acknowledgement from a user device 102 to be sent to the network transaction service 106 to instruct the network transaction service 106 to disallow the requested data transaction 202.

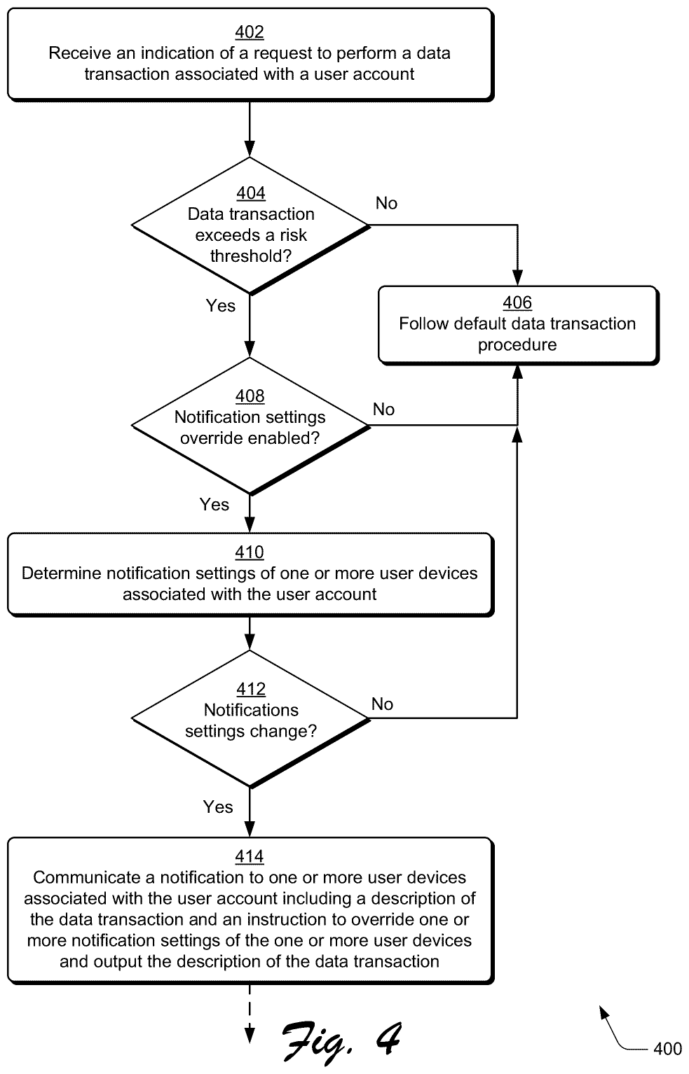

FIG. 4 illustrates a flow chart depicting an example method 400 for notification settings for data transactions in accordance with one or more implementations. Operations of the method 400, for instance, may be performed in the context of the environment 100, such as by the network transaction service 106.

At 402 an indication is received of a request to perform a data transaction associated with a user account. The network transaction service 106, for instance, receives a request from an initiator device 104 to perform a data transaction associated with a user account 118 of the user devices 102. The data transaction can be implemented in various ways, such as a request for access to user data, a request for a finance transaction (e.g., a request for access to value (e.g., money) associated with a user account), a request to manipulate various types of data, and so forth. In at least one implementation the request to perform the data transaction is received from an initiator device 104.

At 404 it is determined whether the data transaction exceeds a risk threshold. The network transaction service 106, for instance, determines a transaction type for the data transaction and a risk level for the transaction type. Examples of different transaction types and risk levels are described throughout this disclosure, such as in Table 1 above. In the context of the transaction types 120, for instance, medium risk transactions 126 and high risk transactions 128 represent data transactions that exceed a risk threshold, whereas low risk transactions 124 represent data transactions that do not exceed a risk threshold.

If the data transaction does not exceed the risk threshold (“No”), at 406 a default data transaction procedure is followed. The network transaction service 106, for instance, allows the data transaction to proceed or requests authorization from a user device to allow the data transaction. If the data transaction exceeds the risk threshold (“Yes”), at 408 it is determined whether a notification settings override option is enabled for one or more user devices associated with the user account. The network transaction service 106, for example, determines whether user devices 102 associated with the user account 118 have a notification settings override option enabled for notifications concerning data transactions that exceed a risk threshold. In at least one implementation a user can interact with the transaction application 112 and/or the network transaction service 106 to configure notification settings override options for data transactions that exceed a risk threshold.

If the notification settings override option is not enabled (“No”), the method proceeds to 406 where a default data transaction procedure is followed. If the notification settings override option is enabled (“Yes”), at 410 notification settings of one or more user devices associated with the user account are determined. In at least one implementation, for example, the network transaction service 106 communicates a settings query to one or more user devices 102 associated with the user account 118. The one or more user devices 102 can then return a query response identifying one or more notification settings of the user devices 102, e.g., current notification settings that are active on the user devices 102.

At 412 it is determined whether a notification settings change is to be implemented by the one or more user devices. The network transaction service 106, for example, determines based on the current notification settings of the one or more user devices whether a notification settings change is to be implemented to enable a notification of the requested data transaction to be output by the one or more user devices. If a notification settings change is not to be implemented by the one or more user devices (“No”), the method proceeds to 406 where a default data transaction procedure is followed. For example, when current notification settings allow for a notification of the requested data transaction to be output by the one or more user devices, the notification can be communicated by the network transaction service 106 to the one or more user devices 102 without the network transaction service 106 communicating an instruction to modify the current notification settings.

If a notification settings change is to be implemented by the one or more user devices (“Yes”), at 414 a notification is communicated to one or more user devices associated with the user account including a description of the data transaction and an instruction to override one or more notification settings of the one or more user devices and output the description of the data transaction. The network transaction service 106, for instance, communicates, based at least in part on the data transaction exceeding the risk threshold, a notification to one or more user devices 102 associated with the user account 118. Further, the notification includes a description of the requested data transaction and an instruction to override one or more notification settings of the one or more user devices 102 and output the description of the requested data transaction via the one or more user devices 102. In at least one implementation the notification identifies the requested data transaction as a data transaction that exceeds the risk threshold, e.g., as a medium risk and/or high risk transaction. Further, the notification can request user instructions regarding the requested data transaction, e.g., whether to allow the data transaction to proceed or to disallow the data transaction.

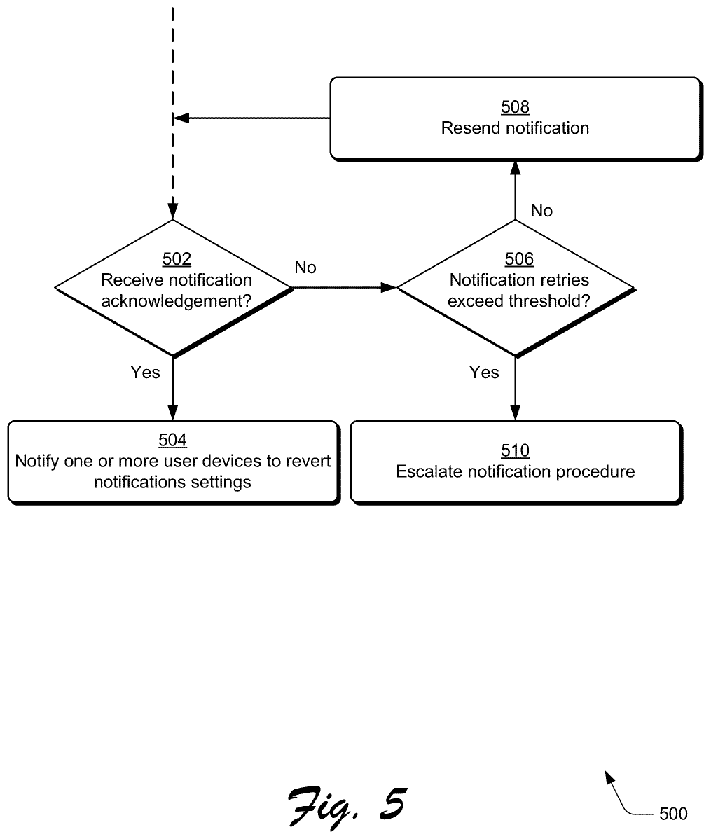

FIG. 5 illustrates a flow chart depicting an example method 500 for notification settings for data transactions in accordance with one or more implementations. Operations of the method 500, for instance, may be performed in the context of the environment 100, such as by the network transaction service 106. Further, the method 500 may represent an extension and/or continuation of the method 400 discussed above.

At 502 it is determined whether an acknowledgement is received of a notification of a data transaction that exceeds a risk threshold. The network transaction service 106, for instance, determines whether the network transaction service 106 receives an acknowledgement from one or more user devices 102 of a notification that a data transaction associated with a user account 118 was requested, and that the data transaction exceeds a risk threshold. One or more user devices 102, for instance, can receive a notification (such as described above) and return an acknowledgement of the notification. In at least one implementation the acknowledgement can include an indication to allow the data transaction or to disallow the data transaction.

If an acknowledgement is received of a notification of a data transaction that exceeds a risk threshold (“Yes”), at 504 one or more user devices are notified to revert notification settings. For example, in response to receiving an acknowledgement of successful receipt and output of the notification of the data transaction by the one or more user devices 102, the network transaction service 106 can communicate a further notification to the one or more user devices 102 to revert notification settings to previous notification settings. The previous notification settings, for instance, represent notification settings that were in effect prior to the instruction from the network transaction service 106 to the one or more user devices 102 to override the notification settings.

If an acknowledgement is not received of a notification of a data transaction that exceeds a risk threshold (“No”), at 506 a determination is made whether a number of notification retries exceeds a notification threshold. A notification threshold, for instance, represents a threshold number of times that the network transaction service 106 communicates a notification to one or more user devices 102 of a data transaction that exceeds a risk threshold, such as described above. If the number of notification retries does not exceed the notification threshold (“No”), at 508 the notification is resent. The network transaction service 106, for example, resends the notification of the data transaction that exceeds the risk threshold and the instruction to override current notification settings. The method can then return to step 502.

If the number of notification retries exceeds the notification threshold (“Yes”), at 510 the notification procedure is escalated. For instance, the network transaction service 106 can cause a phone call and/or other escalated procedure to be performed to attempt to notify a user of the data transaction that exceeds the risk threshold.

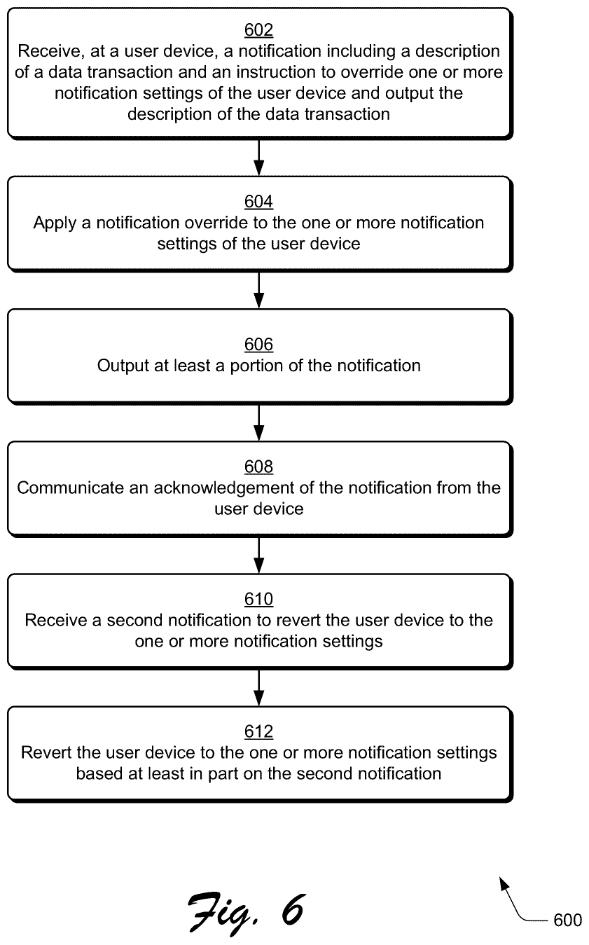

FIG. 6 illustrates a flow chart depicting an example method 600 for notification settings for data transactions in accordance with one or more implementations. Operations of the method 600, for instance, may be performed in the context of the environment 100, such as by one or more user devices 102. At 602 a notification is received at a user device including a description of a data transaction and an instruction to override one or more notification settings of the user device and output the description of the data transaction. One or more user devices 102, for instance, receive the notification from the network transaction service 106. Example attributes of the notification are described above.

At 604 a notification override is applied to the one or more notification settings of the user device. A user device 102, for instance, applies a notification override to override one or more current notification settings and apply one or more override notification settings. Table 2 below presents some non-limiting example current notification settings and override notification settings. Note that each of these notification settings override configurations are individually user configurable and can be enabled and disabled, such as to ensure user privacy and according to user preferences.

TABLE 2

| Current Notification Setting | Override Notification Setting |
|---|---|
| Silent and/or vibrate mode | Audible and/or loud mode |
| Phone out of SMS coverage | Override SMS communication and |
| but has data connectivity | instead perform push/internet messaging |
| (e.g. airplanemode, | notification over data connection |
| but with WiFi on) | |
| User has configured SMS as | |
| the preferred channel for | |
| communication | |
| User in gaming mode with | Override notification suppression |
| suppressed communication | and alert user |
| User on another connected | Turn Notification Sync on |
| device with notification | |
| sync turned off | |
| “Draw over other apps” | Enable “Draw over other apps” |
| setting is disabled | setting automatically for and surface a |
| | button on top of the current app and show |
| | the notification. |

At 606 at least a portion of the notification is output. One or more user devices 102, for instance, output a description of the data transaction and an indication that the data transaction exceeds a risk threshold. In at least one implementation the notification includes selectable options to allow the data transaction to proceed or to disallow the data transaction. A non-limiting example of a notification is illustrated in FIGS. 3a, 3b. At 608 an acknowledgement of the notification is communicated from the user device. One or more user devices 102, for instance, communicate an acknowledgement to the network transaction service 106 that the notification is output.

At 610 a second notification is received to revert the user device to the one or more notification settings. The one or more user devices 102, for example, receive a notification from the network transaction service 106 to revert notification settings back to previous notification settings, e.g., notification settings that were in effect prior to the notification settings override being applied.

At 612 the user device is reverted to the one or more notification settings based at least in part on the second notification. For instance, the one or more user devices 102 revert notification settings back to previous notification settings, e.g., notification settings that were in effect prior to the notification settings override being applied.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of notification settings for data transactions can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the user devices 102, the initiator device 104, and/or the network transaction service 106 as shown and described with reference to FIGS. 1-6 may be implemented as the example device 700.

The device 700 includes communication transceivers 702 that enable wired and/or wireless communication of device data 704 with other devices. The device data 704 can include one or more of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 702.15 (Bluetooth™) standards, wireless local area network (WLAN) radios compliant with any of the various IEEE 702.10 (Wi-Fi™) standards, wireless wide area network (WWAN) radios for cellular phone communication, wireless metropolitan area network (WMAN) radios compliant with various IEEE 702.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes a service application 718 that implements aspects of notification settings for data transactions and may be implemented with hardware components and/or in software as one of the device applications 714. For example, the service application 718 can be implemented as the transaction application 112 described in detail above. In implementations, the service application 718 may include independent processing, memory, and logic components as a computing and/or electronic device integrated with the device 700. The device 700 also includes service data 720 for implementing aspects of notification settings for data transactions and may include data from the service application 718, such as data for managing data transaction requests.

In this example, the example device 700 also includes a camera 722 and motion sensors 724, such as may be implemented in an inertial measurement unit (IMU). The motion sensors 724 can be implemented with various sensors, such as a gyroscope, an accelerometer, and/or other types of motion sensors to sense motion of the device. The various motion sensors 724 may also be implemented as components of an inertial measurement unit in the device.

The device 700 also includes a wireless module 726, which is representative of functionality to perform various wireless communication tasks. The device 700 can also include one or more power sources 728, such as when the device is implemented as a mobile device. The power sources 728 may include a charging and/or power system, and can be implemented as a flexible strip battery, a rechargeable battery, a charged super-capacitor, and/or any other type of active or passive power source.

The device 700 also includes an audio and/or video processing system 730 that generates audio data for an audio system 732 and/or generates display data for a display system 734. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 736. In implementations, the audio system and/or the display system are integrated components of the example device. Alternatively, the audio system and/or the display system are external, peripheral components to the example device.

Although implementations of notification settings for data transactions have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a system including: one or more processors; and computer-readable storage media storing instructions that are executable by the one or more processors to: receive an indication of a request to perform a data transaction associated with a user account; determine that the data transaction exceeds a risk threshold; and communicate, based at least in part on the data transaction exceeding the risk threshold, a notification to one or more user devices associated with the user account, the notification including a description of the data transaction and an instruction to override one or more notification settings of the one or more user devices and output the description of the data transaction.

In some aspects, the techniques described herein relate to a system, wherein the instructions are executable by the one or more processors to receive the indication of the request to perform the data transaction from a device that is not one of the one or more user devices.

In some aspects, the techniques described herein relate to a system, wherein to determine that the data transaction exceeds the risk threshold, the instructions are executable by the one or more processors to: categorize the data transaction into a transaction type; compare the transaction type to multiple different transaction risk levels to determine a transaction risk level for the transaction type; and determine that the transaction risk level exceeds the risk threshold.

In some aspects, the techniques described herein relate to a system, wherein the instructions are executable by the one or more processors to: determine the one or more notification settings of the one or more user devices; and include the instruction to override the one or more notification settings based at least in part on the one or more notification settings indicating that the notification is not to be output.

In some aspects, the techniques described herein relate to a system, wherein to determine the one or more notification settings of the one or more user devices, the instructions are executable by the one or more processors to: communicate one or more settings queries to the one or more user devices requesting the one or more notification settings; and receive one or more query responses from the one or more user devices identifying the one or more notification settings.

In some aspects, the techniques described herein relate to a system, wherein: the one or more notification settings include an indication that the one or more user devices are outside of short message service (SMS) coverage, have data connectivity, and are configured for SMS communication; and the instruction to override the one or more notification settings of the one or more user devices includes an instruction to override SMS communication and enable one or more of a push notification or internet messaging over the data connectivity.

In some aspects, the techniques described herein relate to a system, wherein: the one or more notification settings include an indication a first user device of the one or more user devices is in a notification enabled mode and that a user is authenticated with a second user device of the one or more user devices; the one or more notification settings include an indication that a notification synchronization mode of the second user device is in an off mode; and the instruction to override the one or more notification settings of the one or more user devices includes an instruction to transition the notification synchronization mode of the second user device to an on mode.

In some aspects, the techniques described herein relate to a system, wherein: the one or more notification settings include an indication that a modal setting of the one or more user devices indicates that the notification is not to be presented over a current application presented on the one or more user devices; and the instruction to override the one or more notification settings of the one or more user devices includes an instruction to present at least a portion of the notification over the current application presented on the one or more user devices.

In some aspects, the techniques described herein relate to a system, wherein the instructions are executable by the one or more processors to: receive an acknowledgement of the notification from the one or more user devices; and communicate a second notification to the one or more user devices to revert the one or more user devices to the one or more notification settings.

In some aspects, the techniques described herein relate to a method including: receiving an indication of a request to perform a data transaction associated with a user account; determining that the data transaction exceeds a risk threshold; and communicating, based at least in part on the data transaction exceeding the risk threshold, a notification to one or more user devices associated with the user account, the notification including a description of the data transaction and an instruction to override one or more notification settings of the one or more user devices and output the description of the data transaction.

In some aspects, the techniques described herein relate to a method, wherein determining that the data transaction exceeds a risk threshold includes: categorizing the data transaction into a transaction type; comparing the transaction type to multiple different transaction risk levels to determine a transaction risk level for the transaction type; and determining that the transaction risk level exceeds the risk threshold.

In some aspects, the techniques described herein relate to a method, further including: determining the one or more notification settings of the one or more user devices; and including the instruction to override the one or more notification settings based at least in part on the one or more notification settings indicating that the notification is not to be output.

In some aspects, the techniques described herein relate to a method, wherein determining the one or more notification settings of the one or more user devices includes: communicating one or more settings queries to the one or more user devices requesting the one or more notification settings; and receiving one or more query responses from the one or more user devices identifying the one or more notification settings.

In some aspects, the techniques described herein relate to a method, further including: determining that an acknowledgement of the notification is not received from the one or more user devices after a threshold number of notification retries; determining that the data transaction exceeds a second risk threshold; and communicating a further notification to a security service based at least in part on the data transaction exceeding the second risk threshold.

In some aspects, the techniques described herein relate to a method, further including: receiving an acknowledgement of the notification from the one or more user devices; and communicating a second notification to the one or more user devices to revert the one or more user devices to the one or more notification settings.

In some aspects, the techniques described herein relate to a device including: one or more processors; and computer-readable storage media storing instructions that are executable by the one or more processors to: receive, at the device, a notification including a description of a data transaction and an instruction to override one or more notification settings of the device and output the description of the data transaction; apply a notification override to the one or more notification settings of the device; and output at least a portion of the notification.

In some aspects, the techniques described herein relate to a device, wherein the instructions are executable by the one or more processors to: receive a settings query requesting the one or more notification settings of the device; and communicate a query response indicating the one or more notification settings.

In some aspects, the techniques described herein relate to a device, wherein: the device is outside of short message service (SMS) coverage, has data connectivity, and is configured for SMS communication; and the instructions are executable by the one or more processors to override the one or more notification settings to override SMS communication and enable one or more of a push or internet messaging notification over the data connectivity.

In some aspects, the techniques described herein relate to a device, wherein: the one or more notification settings include an indication that a notification synchronization mode of the device is in an off mode; and the instructions are executable by the one or more processors to override the one or more notification settings to transition the notification synchronization mode of the device to an on mode to enable the user device to receive the notification.

In some aspects, the techniques described herein relate to a device, wherein the instructions are executable by the one or more processors to: communicate an acknowledgement of the notification from the device; receive a second notification to revert the device to the one or more notification settings; and revert the device to the one or more notification settings based at least in part on the second notification.

1. A system comprising:
one or more processors; and
computer-readable storage media storing instructions that are executable by the one or more processors to:
receive an indication of a request to perform a data transaction associated with a user account;
determine that the data transaction exceeds a risk threshold; and
communicate, based at least in part on the data transaction exceeding the risk threshold, a notification to one or more user devices associated with the user account, the notification including a description of the data transaction and an instruction to override one or more notification settings of the one or more user devices and output the description of the data transaction.

2. The system of claim 1, wherein the instructions are executable by the one or more processors to receive the indication of the request to perform the data transaction from a device that is not one of the one or more user devices.

3. The system of claim 1, wherein to determine that the data transaction exceeds the risk threshold, the instructions are executable by the one or more processors to:
categorize the data transaction into a transaction type;
compare the transaction type to multiple different transaction risk levels to determine a transaction risk level for the transaction type; and
determine that the transaction risk level exceeds the risk threshold.

4. The system of claim 1, wherein the instructions are executable by the one or more processors to:
determine the one or more notification settings of the one or more user devices; and
include the instruction to override the one or more notification settings based at least in part on the one or more notification settings indicating that the notification is not to be output.

5. The system of claim 4, wherein to determine the one or more notification settings of the one or more user devices, the instructions are executable by the one or more processors to:
communicate one or more settings queries to the one or more user devices requesting the one or more notification settings; and
receive one or more query responses from the one or more user devices identifying the one or more notification settings.

6. The system of claim 5, wherein:
the one or more notification settings comprise an indication that the one or more user devices are outside of short message service (SMS) coverage, have data connectivity, and are configured for SMS communication; and
the instruction to override the one or more notification settings of the one or more user devices comprises an instruction to override SMS communication and enable one or more of a push notification or internet messaging over the data connectivity.

7. The system of claim 5, wherein:
the one or more notification settings comprise an indication a first user device of the one or more user devices is in a notification enabled mode and that a user is authenticated with a second user device of the one or more user devices;
the one or more notification settings comprise an indication that a notification synchronization mode of the second user device is in an off mode; and
the instruction to override the one or more notification settings of the one or more user devices comprises an instruction to transition the notification synchronization mode of the second user device to an on mode.

8. The system of claim 5, wherein:
the one or more notification settings comprise an indication that a modal setting of the one or more user devices indicates that the notification is not to be presented over a current application presented on the one or more user devices; and
the instruction to override the one or more notification settings of the one or more user devices comprises an instruction to present at least a portion of the notification over the current application presented on the one or more user devices.

9. The system of claim 1, wherein the instructions are executable by the one or more processors to:
receive an acknowledgement of the notification from the one or more user devices; and
communicate a second notification to the one or more user devices to revert the one or more user devices to the one or more notification settings.

10. A method comprising:
receiving an indication of a request to perform a data transaction associated with a user account;
determining that the data transaction exceeds a risk threshold; and
communicating, based at least in part on the data transaction exceeding the risk threshold, a notification to one or more user devices associated with the user account, the notification including a description of the data transaction and an instruction to override one or more notification settings of the one or more user devices and output the description of the data transaction.

11. The method of claim 10, wherein determining that the data transaction exceeds a risk threshold comprises:
categorizing the data transaction into a transaction type;
comparing the transaction type to multiple different transaction risk levels to determine a transaction risk level for the transaction type; and
determining that the transaction risk level exceeds the risk threshold.

12. The method of claim 10, further comprising:
determining the one or more notification settings of the one or more user devices; and
including the instruction to override the one or more notification settings based at least in part on the one or more notification settings indicating that the notification is not to be output.

13. The method of claim 12, wherein determining the one or more notification settings of the one or more user devices comprises:
communicating one or more settings queries to the one or more user devices requesting the one or more notification settings; and
receiving one or more query responses from the one or more user devices identifying the one or more notification settings.

14. The method of claim 10, further comprising:
determining that an acknowledgement of the notification is not received from the one or more user devices after a threshold number of notification retries;
determining that the data transaction exceeds a second risk threshold; and
communicating a further notification to a security service based at least in part on the data transaction exceeding the second risk threshold.

15. The method of claim 10, further comprising:
receiving an acknowledgement of the notification from the one or more user devices; and
communicating a second notification to the one or more user devices to revert the one or more user devices to the one or more notification settings.

16. A device comprising:
one or more processors; and
computer-readable storage media storing instructions that are executable by the one or more processors to:
receive, at the device, a notification including a description of a data transaction and an instruction to override one or more notification settings of the device and output the description of the data transaction;
apply a notification override to the one or more notification settings of the device; and
output at least a portion of the notification.

17. The device of claim 16, wherein the instructions are executable by the one or more processors to:
receive a settings query requesting the one or more notification settings of the device; and
communicate a query response indicating the one or more notification settings.

18. The device of claim 16, wherein:
the device is outside of short message service (SMS) coverage, has data connectivity, and is configured for SMS communication; and
the instructions are executable by the one or more processors to override the one or more notification settings to override SMS communication and enable one or more of a push or internet messaging notification over the data connectivity.

19. The device of claim 16, wherein:
the one or more notification settings comprise an indication that a notification synchronization mode of the device is in an off mode; and
the instructions are executable by the one or more processors to override the one or more notification settings to transition the notification synchronization mode of the device to an on mode to enable the user device to receive the notification.

20. The device of claim 16, wherein the instructions are executable by the one or more processors to:
communicate an acknowledgement of the notification from the device;
receive a second notification to revert the device to the one or more notification settings; and
revert the device to the one or more notification settings based at least in part on the second notification.
